(19) United States
(12) Patent Application Publication
(10) Pub. No.: US 2014/0164062 A1
(43) Pub. Date: Jun. 12, 2014

(54) SYSTEMS AND METHODS FOR PERFORMING SOCIO-GRAPHIC CONSUMER SEGMENTATION FOR TARGETED ADVERTISING

(71) Applicants: Andrew Wen, Palo Alto, CA (US); James Patterson, Washington, DC (US)

(72) Inventors: Andrew Wen, Palo Alto, CA (US); James Patterson, Washington, DC (US)

(73) Assignee: CAPITAL ONE FINANCIAL CORPORATION, McLean, VA (US)

(21) Appl. No.: 14/097,421

(22) Filed: Dec. 5, 2013

Related U.S. Application Data
(60) Provisional application No. 61/733,985, filed on Dec. 6, 2012.

(51) Int. Cl. G06Q 30/02

(52) U.S. Cl. CPC G06Q 30/0204; G06Q 30/0224; G06Q 30/0251
USPC 705/7.33

(57) ABSTRACT

Systems and methods are disclosed for determining the financial characteristics of socio-graphic segments of social media users. A financial service system links a customer's social network profile to a financial service account associated with the customer. The financial service system may receive information relating to the social network profile, and identify one or more characteristics of the customer based on the information. The financial service system may proceed to associate the customer with one or more socio-graphic groups, or “clusters,” comprising customers sharing the same characteristic. The financial service system may then generate a spending model associated with the clusters, and provide it to advertisers for purposes of generating more useful, targeted advertising and incentives to the customers.

### CROSS-REFERENCE TO RELATED APPLICATIONS

This application claims priority under 35 U.S.C. §119 to U.S. Provisional Application No. 61/733, 985, filed on Dec. 6, 2012, which is expressly incorporated herein by reference in its entirety.

### FIELD

The disclosed embodiments generally relate to generating targeted advertising to groups of customers, particularly based on the customers' presence on one or more social networks.

### BACKGROUND

One of the best ways for a retailer to increase profits is to learn more about their customer base in order to better know what products and incentives to offer them. Tailoring incentives to a particular audience has two benefits: it reduces wasted advertising dollars spent on customers that would never purchase the advertised product or service, and it increases the chances that customers who redeem the incentive will become a loyal user of the good or service.

Social media has become a regular part of modern life. Many customers participate in multiple social networks, blogs, and other such sites, and the customers often share information there about themselves, their interests, and even their buying habits. In many ways, social media can serve as a low-cost, effective form of market research for a retailer. By aggregating and analyzing social media, retailers can learn more about their current customers as well as discover and target new customers to their brand or business. Current methods for gathering information on social media, however, can be time-consuming and expensive. The sheer number of social networks and social network users creates an overwhelming amount of data and, thus, an overwhelming amount of noise. It is currently difficult for a retailer to learn useful information from social media beyond simply setting up their own presence and interacting with customers in that way. But merely setting up a social media storefront may miss out on other insights into customer behavior that could provide a critical business advantage.

Accordingly, there is a need to provide more relevant and comprehensive data to retailers related to customer behavior on social media.

### SUMMARY

Methods, systems, and articles of manufacture described herein enable a computer system to provide targeted advertising to groups of customers, particularly based on the customers' presence on one or more social networks. In one embodiment, a computing system may receive an authorization to link a customer's social network profile to a financial service account associated with the customer. The computing system may further receive social network profile information associated with the customer from the social network based on the authorization. Also, the computing system may identify at least one characteristic of the customer based on the received social network profile information. The computing system may additionally associate the customer with one or more groups of customers based on the identified at least one characteristic, wherein the one or more groups comprise other customers sharing at least one characteristic with the customer. Further, the computing system may generate a financial spending model associated with the identified characteristic based on at least the one or more groups of customers.

In another embodiment, a computer-implemented method is provided for determining the financial characteristics of socio-graphic segments of customers. The method comprises receiving an authorization to link a customer's social network profile to a financial service account associated with the customer. The method may further include receiving social network profile information associated with the customer from the social network based on the authorization. Also, the method may comprise identifying, via the one or more processors, at least one characteristic of the customer based on the received social network profile information. The method may additionally include associating the customer with one or more groups of customers based on the identified at least one characteristic, wherein the one or more groups comprise other customers sharing at least one characteristic with the customer. Further, the method may include generating, via the one or more processors, a financial spending model associated with the identified characteristic based on at least the one or more groups of customers.

In yet another embodiment, a computing system is disclosed for providing targeted advertising suggestions. The computing system may receive a set of customer characteristics from an advertiser interested in targeting customers, the set of characteristics comprising one or more socio-graphic traits selected by the advertiser for analysis. The computing system may further generate a financial spending model for the set of customer characteristics based on the one or more socio-graphic traits. Also, the computing system may receive an indication of one or more advertising goals from the advertiser. The computing system may additionally determine a set of potential customers to target with advertising based on the generated financial spending model and the one or more advertising goals. Further, the computing system may rank each of the potential customers to target with advertising for the advertiser based on the generated financial spending model and the one or more advertising goals.

Although disclosed embodiments are discussed primarily in the context of targeted advertising, other applications are contemplated. For example, disclosed embodiments may be also used in the context of credit underwriting.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 illustrates an exemplary system for performing socio-graphic consumer segmentation and targeted advertising, consistent with disclosed embodiments.

FIG. 2 illustrates another exemplary system performing socio-graphic consumer segmentation and targeted advertising, consistent with disclosed embodiments.

FIG. 3 depicts a flowchart of an exemplary method for performing socio-graphic consumer segmentation, consistent with disclosed embodiments.

FIG. 4 depicts a flowchart of an exemplary method for receiving authorization to link user's social network profiles with user's financial accounts, consistent with disclosed embodiments.

FIG. 5 depicts a flowchart of an exemplary method for receiving social network profile data from social network, consistent with disclosed embodiments.

FIG. 6 depicts a flowchart of an exemplary method for associating users with socio-graphic clusters, consistent with disclosed embodiments.

FIG. 7 depicts a flowchart of an exemplary method for generating financial spending models based on socio-graphic clusters, consistent with disclosed embodiments.

FIG. 8 depicts a flowchart of an exemplary method for generating targeted advertising suggestions, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

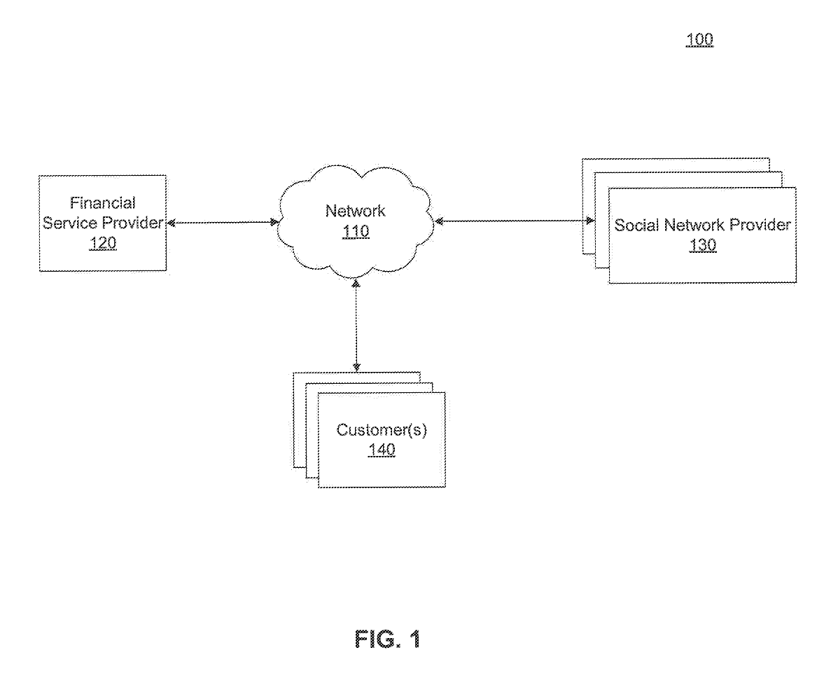

FIG. 1 is a diagram illustrating an exemplary system 100 for dynamically determining the financial characteristics of finely defined socio-graphic segments. The components and arrangement of the components described in FIG. 1 may vary. System 100 may include a network 110, financial service provider system 120, social network provider 130, and customer(s) 140. System 100 may further include any entity or source of information capable of providing information or characteristics regarding individuals or groups of individuals.

Network 110 may be any type of network configured to provide communications between components of system 100. For example, network 110 may be any type of network (including infrastructure) that provides communications, exchanges information, and/or facilitates the exchange of information, such as the Internet, a Local Area Network, or other suitable connection(s) that enables system 100 to send and receive information between the components of system 100. In other embodiments, one or more components of system 100 may communicate directly through a dedicated communication medium.

Financial service provider system 120 may be a system that is associated with a financial service provider that provides and manages financial service accounts, such as a bank, credit card company, etc. Financial service provider system 120 may additionally determine financial characteristics of customers according to finely defined socio-graphic segments. In one embodiment, financial service provider system 120 may include one or more computing systems that are located at a central location or may include computing devices that are distributed (locally or remotely). In one example, financial service provider system 120 may include a server that is configured to execute software instructions stored in one or more memory devices to perform one or more operations consistent with the disclosed embodiments.

Social network provider system 130 may be a system associated with a social network comprising a web based online community. Although disclosed embodiments are discussed primarily in the context of coordinating with online social networks to determine spending characteristics of a customer, any source of information regarding a customer and the customer's spending tendencies is contemplated.

Customer 140 may be a customer of financial service provider system 120 and/or a user of social network provider system 130. Customer 140 may communicate with financial service provider system 120 or social network provider system 130 using any suitable computer device or system (not shown). Customer 140 may additionally be an advertising user wishing to employ disclosed embodiments to determine suitable persons or groups of persons to solicit with targeted advertising.

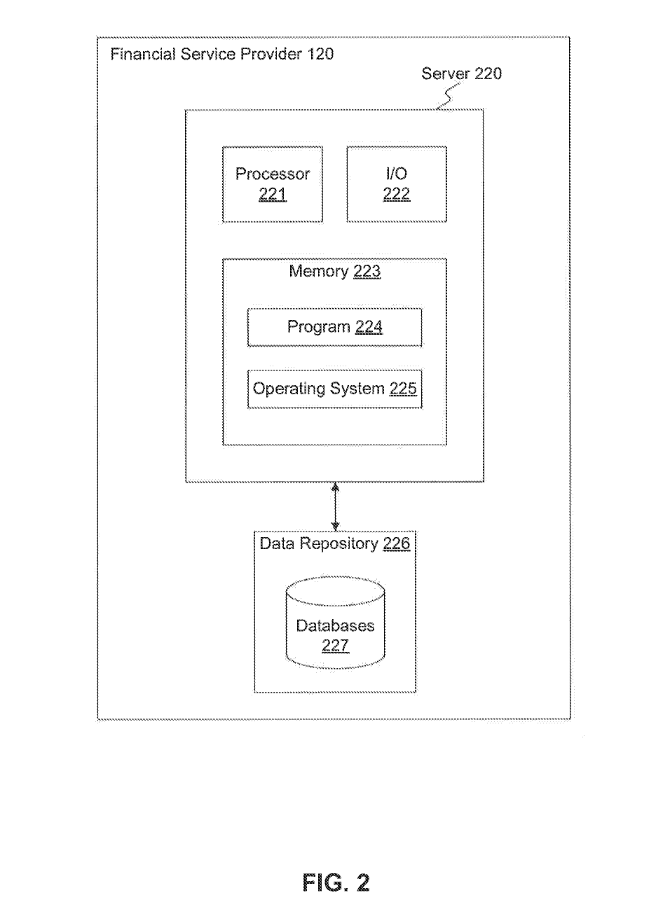

FIG. 2 illustrates an exemplary system that may be associated with financial service provider system 120. In one embodiment, the system may include a server 220 having one or more processors 221, one or more memories 223, and one or more input/output (I/O) devices 222. Alternatively, server 220 may take the form of a general purpose computer, a mainframe computer, or any combination of these components. Server 220 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems.

Memory 223 may include one or more storage devices configured to store instructions used by processor 221 to perform functions related to disclosed embodiments. For example, memory 223 may be configured with program 224 that performs several functions when executed by processor 221. Therefore, the disclosed embodiments are not limited to separate programs or computers configured to perform dedicated tasks. For example, memory 223 may include a single program 224 that performs the functions of the server 120, or program 224 could comprise multiple programs. Additionally, processor 221 may execute one or more programs located remotely from server 220. For example, financial service provider system 120 may access one or more remote programs that, when executed, perform functions related to disclosed embodiments.

Memory 223 may also be configured with operating system 225 that performs several functions well known in the art when executed by server 220. By way of example, the operating system may be Microsoft Windows™, Unix™, Linux™, Solaris™, or some other operating system. The choice of operating system, and even the use of an operating system, is not critical to any disclosed embodiment.

I/O devices 222 may be one or more devices that are configured to allow data to be received and/or transmitted by server 220. I/O devices 222 may include one or more digital and/or analog communication devices that allow server 220 to communicate with other machines and devices, such as customers 140.

Server 220 may also be communicatively connected to one or more data repositories 226 as shown in FIG. 2. Server 220 may be communicatively connected to data repository 226 through network 110. Data repository 226 may include one or more files or databases 227 that store information and are accessed and/or managed through server 220. By way of example, databases 227 may be Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider system 120 may include data repository 226. Alternatively, data repository 226 may be located remotely from financial service provider system 120.

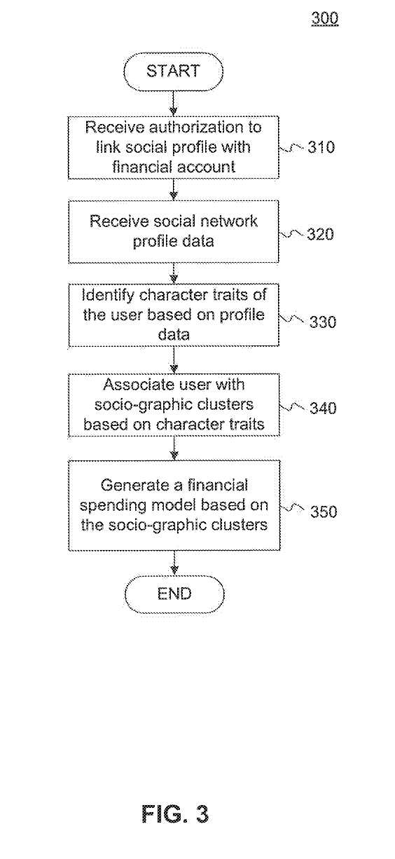

FIG. 3 is a flow diagram of an exemplary method for performing socio-graphic consumer segmentation, consistent with disclosed embodiments.

In step 310, server 220 may receive authorization from a customer (such as customer 140) to link a financial account associated with the customer with a social network account associated with the customer via network 110. In step 320, server 220 may receive data or information associated with the customer's social network profile. Based on the received social network profile information, server 220 may identify one or more character traits of customer 140 (step 330). In some embodiments, character traits of customer 140 may include preferences for one or more brands of a particular product or products in the marketplace. In some embodiments, a character trait of customer 140 may include their influence amongst friends. Customer 140's influence may be evidenced, for example, by one or more of their number of connections (or “friends”) on social network provider system 130, the number of views that posts by customer 140 receive on social network provider system 130, the number of “likes” or other such affirmation by other users that posts by customer 140 receive on social network provider system 130, etc. In some embodiments, character traits of customer 140 may comprise interests indicated by the topics that the customer actively discusses on social network provider system 130. In other embodiments, character traits of customer 140 may include interests indicated by the topics that the customer regularly views or otherwise passively engages in on social network provider system 130. Further, in some embodiments, character traits of customer 140 may include their purchasing behavior on social network provider system 130, such as applications, games, gifts, or any other purchase that may be transacted on or using the social network. It is understood that this list is not intended to be limiting, and server 220 may identify any observable trait of customer 140 via social network provider system 130.

In step 340, server 220 may associate a customer, such as customer 140, with one or more socio-graphic clusters based on the identified character traits of the customer. Server 220 may also consider information from other sources, including information associated with a financial account configured for the customer by financial service provider system 120. Server 220 may identify any number of identifiable segments/clusters of varying specificity. For example, server 220 may determine that the customer should be associated with one or more clusters including:
“Influential Sports Enthusiasts” (e.g., the customer receives a significant amount of feedback on posts on social network provider system 130 regarding sports topics),
“Passive Consumers of Live Entertainment” (e.g., the customer regularly attends Broadway shows but does not otherwise discuss Broadway on social network provider system 130),
“Fitness Oriented” (e.g., someone who spends a higher than average portion of his/her income on exercise equipment, and/or discusses diet, exercise, or fitness topics on social network provider system 130),
“Local Foodies” (e.g., someone who spends, for example, 90% of their food spending on restaurants within a predetermined distance of his or her residence and/or workplace), and/or
buyers or enthusiasts of a particular brand of clothes.

It is understood that these socio-graphic clusters are presented as non-limiting examples, and that customers such as customer 140 may be clustered by any observable characteristic capable of providing insight on financial spending.

In step 350, server 220 may generate a financial spending model for each of the defined socio-graphic clusters. Server 220 may be configured to use the financial spending models to, for example, dynamically identify marketable characteristics of an individual or group based on character traits of that individual or group. In some embodiments, a marketable characteristic may include preferences for one or more brands present in the marketplace. In other embodiments, a marketable characteristic may include locations or merchants where the individual or group spends disposable income. The locations or merchants may be further classified by geographic location, type of merchant, etc. In some embodiments, marketable characteristics may further comprise one or more interests or hobbies of the individual or group within the cluster. Further, in some embodiments marketable characteristics may include whether the individual or group generates additional spending by others (such as by, for example, providing favorable feedback for a restaurant). It is understood that these marketable characteristics are presented as non-limiting examples, and that any characteristic of a socio-graphic cluster associated with the financial models may be marketable at a given time, in a given place, or associated with a given product.

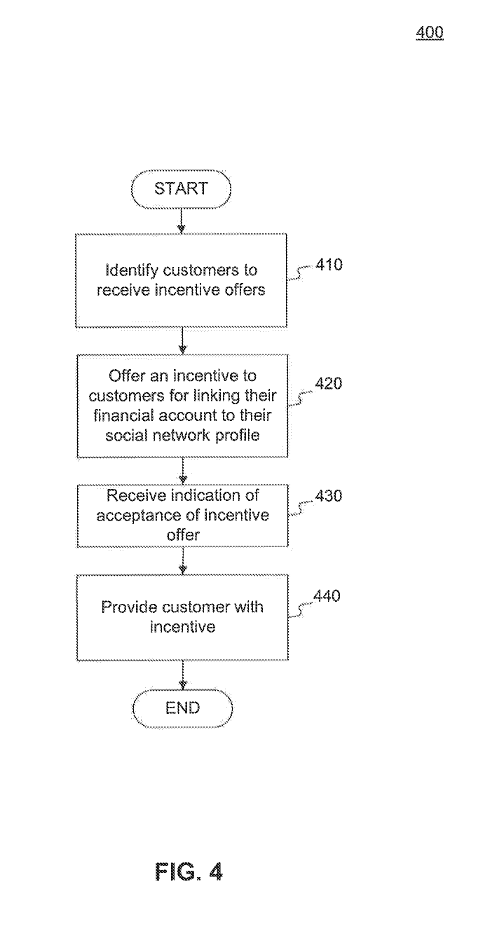

FIG. 4 depicts a flowchart of an exemplary method for receiving authorization to link user's social network profiles with user's financial accounts, consistent with disclosed embodiments.

In step 410, server 220 may identify customers of, for example, financial service provider system 120 to receive incentive offers to link one or more social network profiles with his or her financial account. In step 420, server 220 may offer an incentive to the identified customers. Server 220 may send the offer to the identified customer directly via, for example, text, electronic mail, postal mail, telephonic means, or any form of communication. Server 220 may also send the offer to the identified customer by indirect means via, for example, social network provider system 130. In some embodiments, the offers may take the form of one or more of coupons, credit card reward points, or benefits associated with a particular financial product or service provided by financial service provider system 120 (e.g., adding a personal photo as the backdrop of a financial card). In other embodiments, the offer may comprise, for example, the ability to transfer money through the social networking site of social network provider system 130, free financial planning guides, etc. These offers are presented as non-limiting examples, and it is understood that any incentive offer may be provided to customer 140.

Server 220 may also receive an indication that the customer has accepted the incentive offer (step 430). In step 440, server 220 may further provide the customer with the financial incentive. Server 220 may provide the customer with the financial incentive using one or more communication mechanisms known to those skilled in the art. For example, server 220 may generate a message including the incentive that is provided to the customer via electronic mail, SMS communications, or other forms of communication.

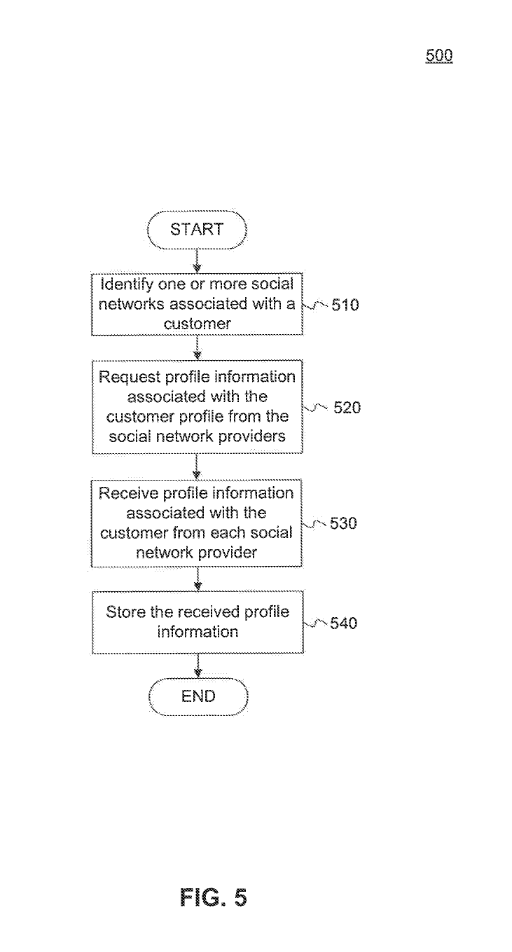

FIG. 5 depicts a flowchart of an exemplary method for receiving social network profile data from social networks, consistent with disclosed embodiments.

In step 510, server 220 may identify one or more social networks associated with the user. Server 220 may obtain social profile data using an authorization key provided by the one or more social networks upon the authorization of the user to link the user's social network profile(s) with the user's financial account(s). For example, the social networks may typically notify the customer that an application, such as an application provided by financial service provider system 120, is requesting permission to access additional profile data from the social network. The customer may accept or decline permission to allow access to the additional profile data. If the customer accepts, the social network may provide an authorization key to the server that may be used to access the additional profile information. In one aspect, server 220 may request profile information associated with the customer for the one or more social networks (step 520). In step 530, server 220 may receive the requested profile information associated with the customer from each of the one or more social network system(s) 130. In step 540, server 220 may store the received profile information. In some embodiments, server 220 may store the received profile information in a memory, such as for example, data repository 226.

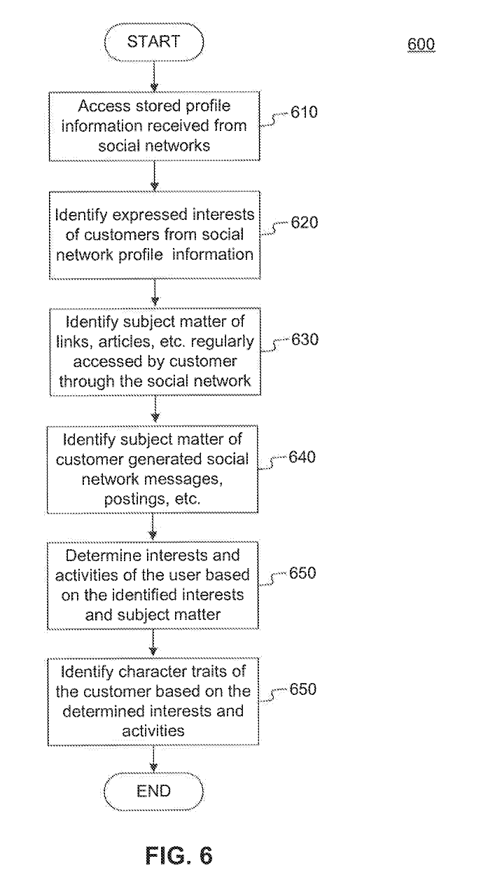

FIG. 6 depicts a flowchart of an exemplary method for associating users with socio-graphic clusters, consistent with disclosed embodiments.

In step 610, server 220 may access stored profile information received from one or more social network provider systems 130. In step 620, server 220 may identify one or more expressed interests of a customer (such as customer 140) based on the stored profile information. For example, the received social network profile information may include information regarding a section of a social network profile entitled “Interests” where customer 140 has listed or otherwise compiled a set of personal interests. In step 630, server 220 may identify the subject matter of one or more links, articles, and the like that customer 140 has accessed via the social networking site. For example, server 220 may determine that customer 140 regularly follows links associated with articles on restoring automobiles. According to some embodiments, publishers of online media may embed a third-party cookie from the social network that permits the social network to detect the links, articles, and the like that customer 140 has accessed. In step 640, server 220 may identify the subject matter of user-generated messages, blog entries, postings, etc. In some embodiments, server 220 may use content classification services that categorize articles, for example, to identify the subject matter of the user-generated content. For example, server 220 may determine that customer 140 regularly comments on a blog associated with a particular sports team. In some embodiments, server 220 may further determine that the customer has a following in a subject area in which he or she frequently posts. For example, server 220 may determine a sizable number of other users of social network provider system 130 “follow” customer 140's profile and/or postings. In some embodiments, the social network profile data may include lists of followers or fans of the content that customer 140 posts. In still other embodiments, server 220 may determine that other users take action (e.g., make purchases) based on customer 140's social media posts. In some embodiments, social network provider system 130 may provide server 220 with identifying information associated with other users of the social network who have taken observable actions. In some embodiments, observable actions may include, for example, commenting or “liking” customer 140's social media post. In step 650, server 220 may determine the interest and activities of customer 140 based on the identified subject matter of steps 620-640. Server 220 may further identify specific character traits of customer 140 based on the determined interests and activities, such as an ability to influence others, brand preferences, and/or other purchasing tendencies (step 660). According to some embodiments, social influence may be determined based on how often customer 140's posts are liked, commented, re-posted, or the like, where some action is taken to editorialize or promote the customer's content.

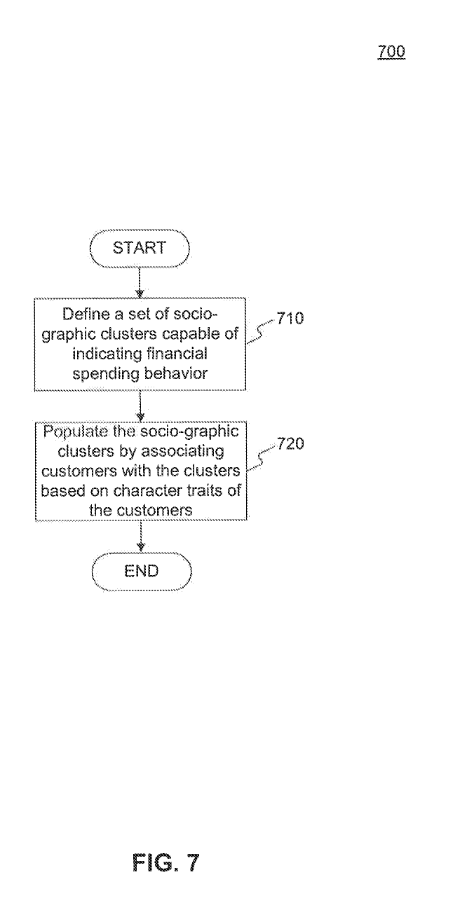

FIG. 7 depicts a flowchart of an exemplary method for generating financial spending models based on socio-graphic clusters, consistent with disclosed embodiments.

In step 710, server 220 may define a set of socio-graphic clusters capable of indicating financial spending behavior. In some embodiments, server 220 may employ known cluster analysis schemes and/or groupings, such as PRIZM codes, BlueKAI, and/or any other behavior segmentation lists. In other embodiments, server 220 may create the clusters/segments. Clusters may be defined as groups of users with the highest degree of similarity based on the desired dimensions. This may be based on, for example, interest, actions, or other profile information known to server 220. Further, the defined clusters may be hierarchical. For example, a “sports enthusiast” cluster may be a higher node in a clustering hierarchy to the node “Boston Celtics enthusiast.” Server 220 may also populate the defined socio-graphic clusters by associating a plurality of customers who have opted to link their social network profile associated with social network provider system 130 with their financial account with one or more of the defined clusters based on character traits identified for those customers (step 720). In certain embodiments, server 220 may execute software that performs cluster analysis processes known in the art.

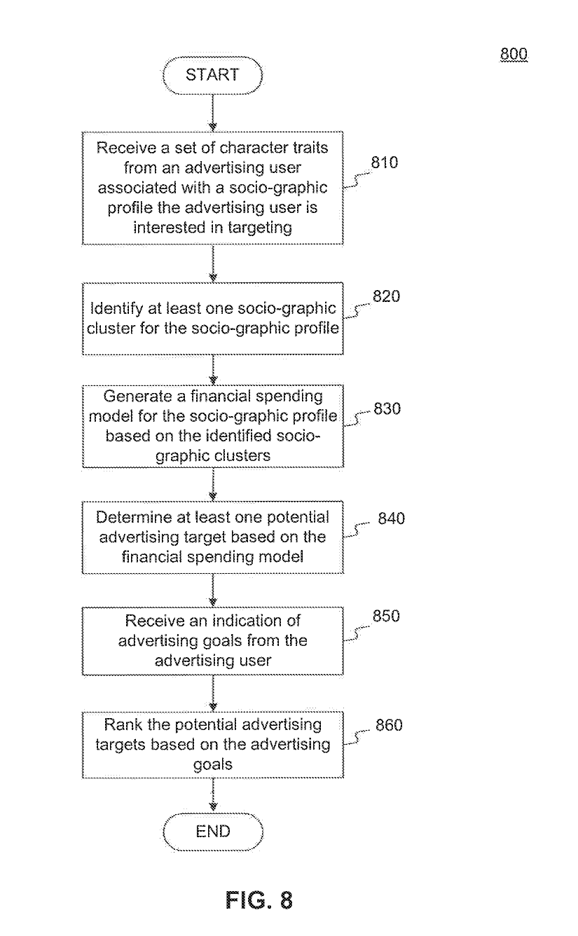

FIG. 8 depicts a flowchart of an exemplary method for generating targeted advertising suggestions, consistent with disclosed embodiments.

In step 810, server 220 may receive a set of character traits associated with a socio-graphic profile. The set of character traits may be provided by, for example, an advertising user interested in advertising to a targeted segment of the population. Based on the received set of character traits, server 220 may identify a socio-graphic profile associated with one or more socio-graphic clusters for the received set of character traits (step 820). Server 220 may further generate a financial spending model that indicates the number of purchases, average purchase size, and total spend over one or more time periods for specific merchants and/or merchant categories for the socio-graphic profile based on the identified socio-graphic clusters (step 830). In step 840, server 220 may determine at least one potential advertising target based on the financial spending model. Additionally or alternatively, server 220 may receive an indication of the advertising goals of the advertising user (step 850). For example, the advertiser may be interested in targeting customers who consistently buy a particular brand of clothing. Server 220 may rank the potential advertising targets based on the advertising goals of the user (step 860).

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims.

What is claimed is:

1. A system for determining the financial characteristics of socio-graphic segments of customers, comprising:
a memory storing instructions; and
a processor configured to execute the instructions to:
receive an authorization to link a customer's social network profile to a financial service account associated with the customer;
receive social network profile information associated with the customer from the social network based on the authorization;
identify at least one characteristic of the customer based on the received social network profile information;
associate the customer with one or more groups of customers based on the identified at least one characteristic, wherein the one or more groups comprise other customers sharing at least one characteristic with the customer; and
generate a financial spending model associated with the identified characteristic based on at least the one or more groups of customers.

2. The system of claim 1, wherein the processor is further configured to execute the instructions to:
generate at least one incentive offer linked to the customer's financial service account based on the financial spending model;
provide the generated incentive offer to the customer; and
receive a notification that the customer has redeemed the incentive offer.

3. The system of claim 2, wherein the incentive offer is provided via the social network profile associated with the customer.

4. The system of claim 3, wherein the customer redeems the incentive offer via the social network profile associated with the customer.

5. The system of claim 1, wherein the identified characteristic comprises one or more of a preference for a particular product or brand, influence among friends, interests, hobbies, or purchasing behavior.

6. The system of claim 1, wherein the financial spending model comprises information associated with one or more of a preference for a particular product or brand among the group of customers, retailers or other entities that receive disposable income from the group of customers, interests of the group of customers, or hobbies of the groups of customers.

7. The system of claim 6, wherein the financial spending model further comprises information relating to social media activities of the group of customers that generates spending by other customers.

8. The system of claim 7, wherein the social media activity of the group of customers comprises providing favorable feedback for a retailer.

9. The system of claim 2, wherein the incentive offer is one or more of a coupon, an award of reward points for a credit card account, a benefit associated with the linked financial service account, an ability to transfer funds via the customer's social network profile, or free financial planning information.

10. A computer-implemented method for determining the financial characteristics of socio-graphic segments of customers, comprising:
receiving an authorization to link a customer's social network profile to a financial service account associated with the customer;
receiving social network profile information associated with the customer from the social network based on the authorization;
identifying, via the one or more processors, at least one characteristic of the customer based on the received social network profile information;
associating the customer with one or more groups of customers based on the identified at least one characteristic, wherein the one or more groups comprise other customers sharing at least one characteristic with the customer; and
generating, via the one or more processors, a financial spending model associated with the identified characteristic based on at least the one or more groups of customers.

11. The method of claim 10, further comprising:
generating, via the one or more processors, at least one incentive offer linked to the customer's financial service account based on the financial spending model;
providing the generated incentive offer to the customer; and
receiving a notification that the customer has redeemed the incentive offer.

12. The method of claim 11, wherein the incentive offer is provided via the social network profile associated with the customer.

13. The method of claim 12, wherein the customer redeems the incentive offer via the social network profile associated with the customer.

14. The method of claim 10, wherein the identified characteristic comprises one or more of a preference for a particular product or brand, influence among friends, interests, hobbies, or purchasing behavior.

15. The method of claim 10, wherein the financial spending model comprises information associated with one or more of a preference for a particular product or brand among the group of customers, retailers or other entities that receive disposable income from the group of customers, interests of the group of customers, or hobbies of the groups of customers.

16. The method of claim 11, wherein the incentive offer is one or more of a coupon, an award of reward points for a credit card account, a benefit associated with the linked financial service account, an ability to transfer funds via the customer's social network profile, or free financial planning information.

17. A system for providing targeted advertising suggestions, comprising:
a memory storing instructions; and
a processor configured to execute the instructions to:
receive a set of customer characteristics from an advertiser interested in targeting customers, the set of characteristics comprising one or more socio-graphic traits selected by the advertiser for analysis;
generate a financial spending model for the set of customer characteristics based on the one or more socio-graphic traits;
receive an indication of one or more advertising goals from the advertiser;
determine a set of potential customers to target with advertising based on the generated financial spending model and the one or more advertising goals; and
rank each of the potential customers to target with advertising for the advertiser based on the generated financial spending model and the one or more advertising goals.

18. The system of claim 17, wherein the set of customer characteristics comprises one or more of a preference for a particular product or brand, influence among friends, interests, hobbies, or purchasing behavior.

19. The system of claim 17, wherein the generated financial spending model comprises information relating to one or more of number of purchase transactions made by the targeted customers, an average amount of the purchase transactions, a total amount spent with a specific retailer during a particular period of time, or a total amount spent with a category of retailers during a particular period of time.

20. The system of claim 17, wherein the processor is further configured to execute the instructions to:
generate at least one incentive offer linked to a customer's financial service account based on the ranking of customers;
provide the generated incentive offer to the customers based on their rank; and
receive a notification that one or more of the customers has redeemed the incentive offer.
